(19) United States
(12) Patent Application Publication
(10) Pub. No.: US 2011/0232142 A1
(43) Pub. Date: Sep. 29, 2011

(54) Ear Tag for Animal Identification

(76) Inventor: Mark Jones, Austin, TX (US)

(21) Appl. No.: 13/034,590

(22) Filed: Feb. 24, 2011

Related U.S. Application Data
(60) Provisional application No. 61/338,823, filed on Feb. 24, 2010.

(51) Int. Cl. A01K 11/00

(52) U.S. Cl. 40/301

(57) ABSTRACT

An ear tag for attachment to an animal for identification comprises a piercing element and a tab portion. The piercing element includes a post having a terminal end and at least one expandable member carried by the post. The expandable member is configured and dimensioned to be pierced through an ear of the animal and to expand and retain the post in the ear after piercing. The piercing element also includes an interior bore extending through the post to the terminal end, the bore dimensioned to receive a portion of a piercing tool. The tab portion is secured to the piercing element, and the ear tag is shaped and dimensioned to receive an indicia for identifying the animal. Air apertures may be provided around the piercing element to permit the piercing to breathe.

### RELATED APPLICATIONS

This application claims priority to provisional application No. 61/338,823, filed Feb. 24, 2010, which is incorporated herein by reference for all purposes.

### BACKGROUND OF THE INVENTION

1. Technical Field

The invention relates in general to animal identification. More specifically, the invention relates to a means for tagging the ear of an animal to allow for identification from a distance.

2. Background Art

Ear tags are used for the identification of domestic livestock and other animals to distinguish individual animals, prevent theft and control disease outbreaks. Prior-art ear tags are available in a variety of materials, sizes, shapes, and colors. These tags typically consist of two-pieces and are applied to the ear with a special applicator tool. Ear tags are preferred to other types of animal identification primarily for their low cost. Acknowledged disadvantages of the prior art ear tags include a high loss rate, a cumbersome multiple piece installation system, a short useful life, and a risk of infection.

It is an object of the present invention to address these and other needs presented by the prior art. Other objects include maintaining low cost and efficient and simple installation.

### SUMMARY OF THE INVENTION

An ear tag for attachment to an animal for identification comprises a piercing element and a tab portion. The piercing element includes a post having a terminal end and at least one expandable member carried by the post. The expandable member is configured and dimensioned to be pierced through an ear of the animal and to expand and retain the post in the ear after piercing. The piercing element also includes an interior bore extending through the post to the terminal end, the bore dimensioned to receive a portion of a piercing tool. The tab portion is secured to the piercing element, and the ear tag is shaped and dimensioned to receive an indicia for identifying the animal.

### BRIEF DESCRIPTION OF THE SEVERAL VIEWS OF THE DRAWINGS

For a more complete understanding of the present invention and its preferred embodiments, and the advantages thereof, reference is now made to the following descriptions taken in conjunction with the accompanying drawings in which:

FIG. 1 is a front elevation view of an ear tag in accordance with the invention.

FIG. 2 is a side elevation view of the ear tag.

FIG. 3 is a sectional edge view of the ear tag along line 3 of FIG. 1.

FIG. 4 is a perspective of the ear tag.

FIG. 5 is a plan view of the ear tag.

FIG. 6 is a front elevation view of the ear tag along line 6 of FIG. 1.

FIG. 7 is a front elevation view of the ear tag along line 7 of FIG. 3.

FIG. 8 is a side elevation view of the ear tag inserted onto the installation tool.

FIG. 9 is a sectional edge view of the ear tag.

FIG. 10 is a perspective view of the installation tool without the ear tag.

### DETAILED DESCRIPTION OF ILLUSTRATIVE EMBODIMENTS

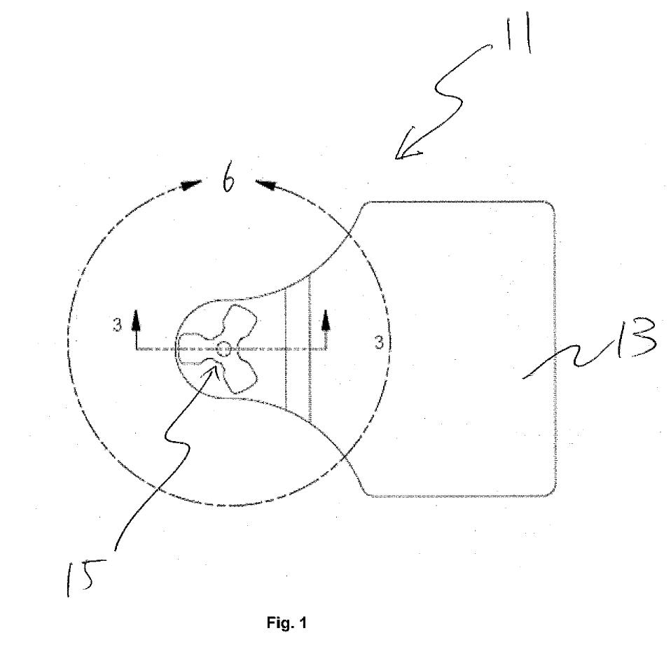

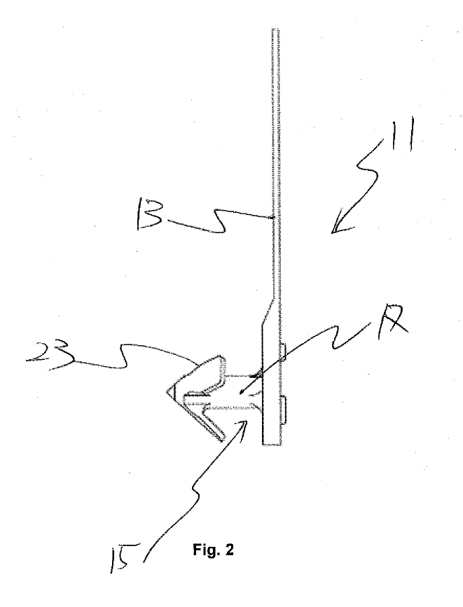

FIGS. 1 and 2 illustrate an exemplary embodiment of the ear tag 11 of the present invention. Ear tag 11 has a tab 13 that is sized and dimensioned to permit printing of a number or other indicia that may identify or distinguish between individual animals or groups of animals. Such indicia could also include a shape, color and graphical exterior markings, such as letters or graphics. The tag may also include an RFID transceiver.

A plurality of, in this case three, barbs 23 extend rearwardly or downwardly at an acute angle from terminal end 25 of a post 17. The barbs 23 are sufficiently flexible to collapse around the post 17 while being pierced through the ear. After piercing, the barbs 23 expand radially outward from the post 17. Once attached, the animal's ear is captured on post 17 between the barbs 23 and the tab 13. The number of barbs may vary according to the applications of the ear tag 11, but three is satisfactory.

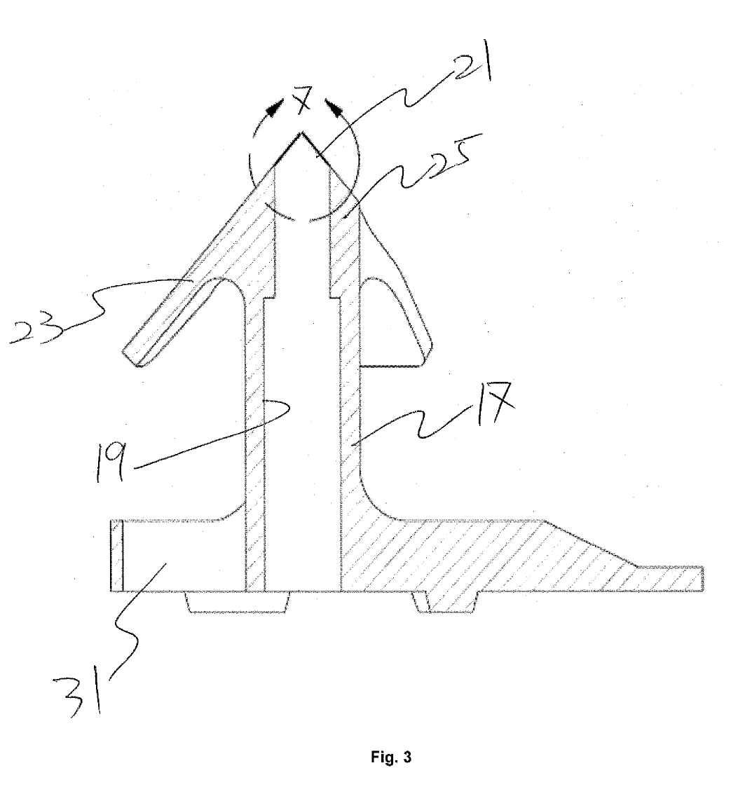

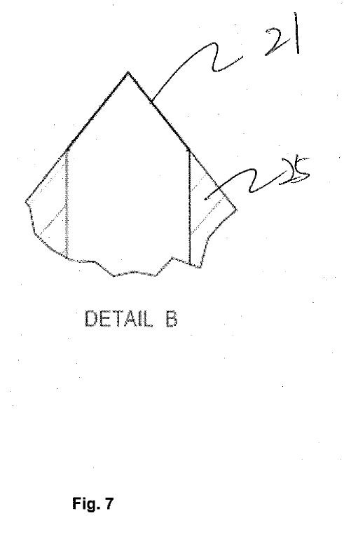

FIG. 3 is a sectional view of the piercing element 15. The piercing element 15 has a post 17 that includes an interior bore 19 and a terminal end 25. The bore 19 extends through the post 17 to the terminal end 25. The bore 19 is dimensioned to receive a portion of a piercing tool 61 and is covered at its terminal end 25 by a membrane 21. Bore 19 is also stepped or has a change in diameter to assist the piercing tool 51 in pushing the post 17 through the animal's ear without buckling. The membrane is a very thin layer of material that prevents entry of fluid or material into the interior bore 19 before and during piercing. The membrane 21 and the piercing tool 61 are discussed in detail with FIGS. 7 and 12, respectively.

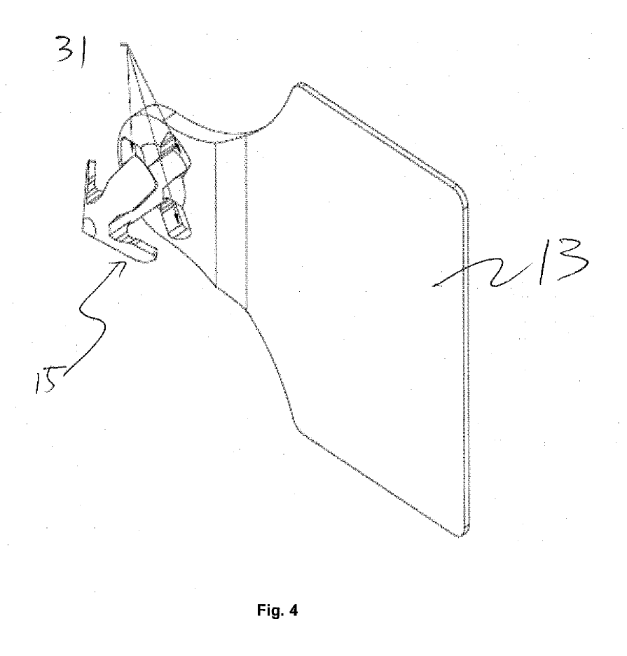

FIG. 4 is a perspective view of the exemplary embodiment and depicts the tab 13 as a thin rectangular shape that tapers to a rounded neck containing a number of oxygen cutouts 31. The oxygen cutouts 31 in the tab 13 surround the post 17, facilitating oxygen flow to the puncture site and thereby promoting rapid healing post puncture. The post 17 extends generally perpendicular to the tab 13, which is generally planar.

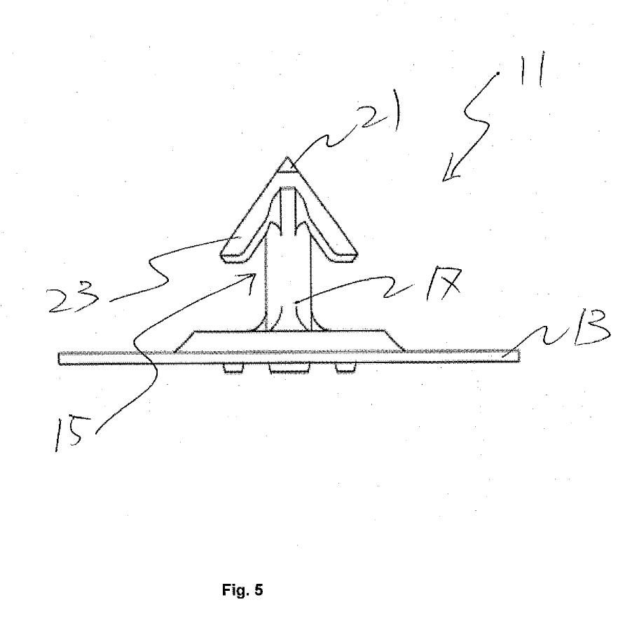

FIG. 5 shows that the width of the barbs 23 is similar to the circumference of the post 17 of the piercing element 15. If constructed of a sufficiently flexible material, the barbs 23 will lay flush against the post 17 during the piercing or insertion process, allowing for ease of installation and less discomfort for the animal.

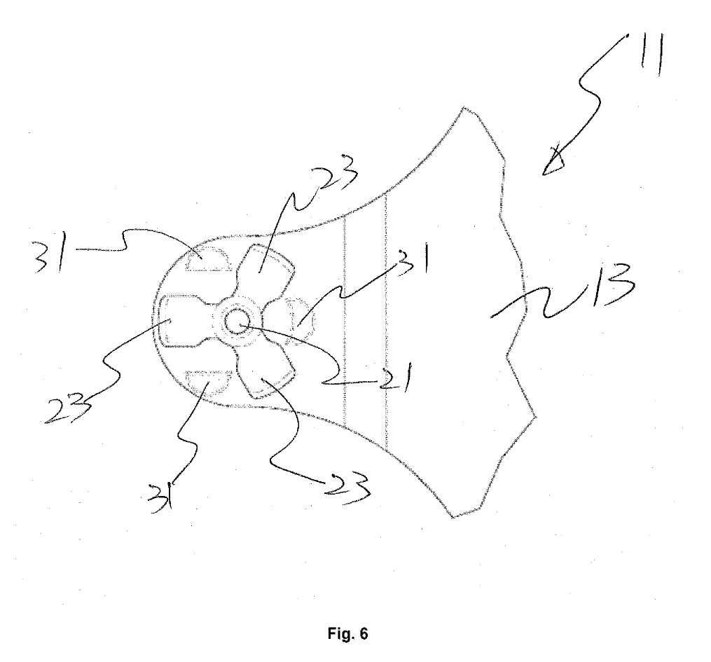

FIG. 6 is a front elevation view of the piercing element 15 depicting three barbs 23 attached at the terminal end 25 of the post 17 in proximity to the membrane 21 and equally spaced around the post 17 of the piercing element 15.

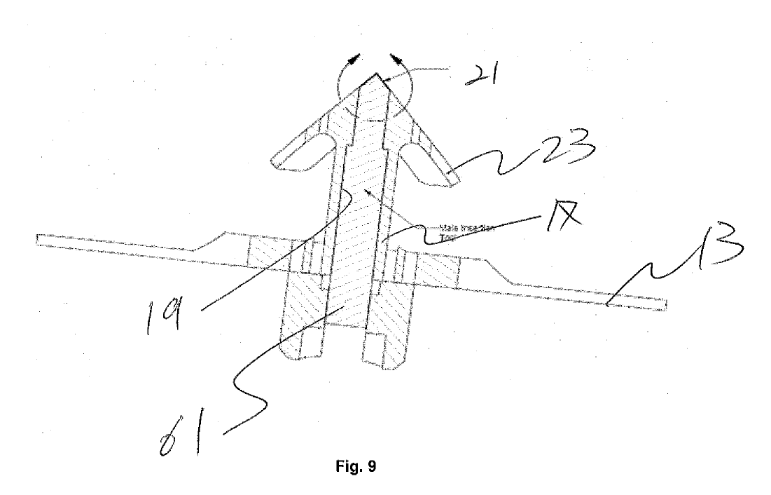

FIG. 7 is a detail view of the terminal end 25 of the piercing element 15. The terminal end 25 and the open end of the interior bore 19 are covered by a prophylactic membrane 21 as depicted in FIG. 9. This prophylactic membrane 21 closes the bore 19 and facilitates infection-free insertion and self-collapses after piercing and installation, thereby eliminating any sharp or pointed tips in contact with the animal's hide. Preferably, the membrane is a thin section of the same material as post 17. It should be thick enough to cover the otherwise open terminal end of post 17, but thin enough to collapse after piercing so that the sharp point is no longer present. Preferably, the entirety of tag 15 is integrally molded from a polymer such as polyethylene or polypropylene.

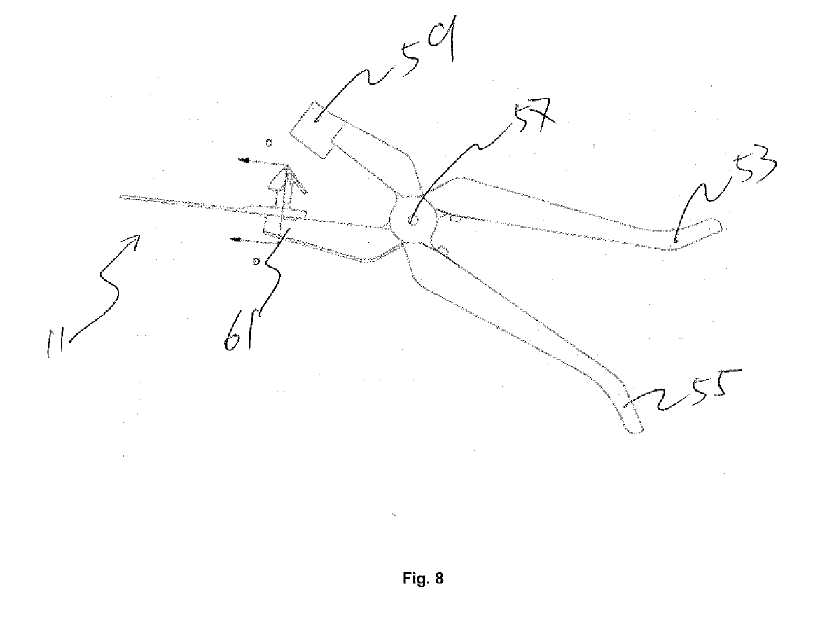

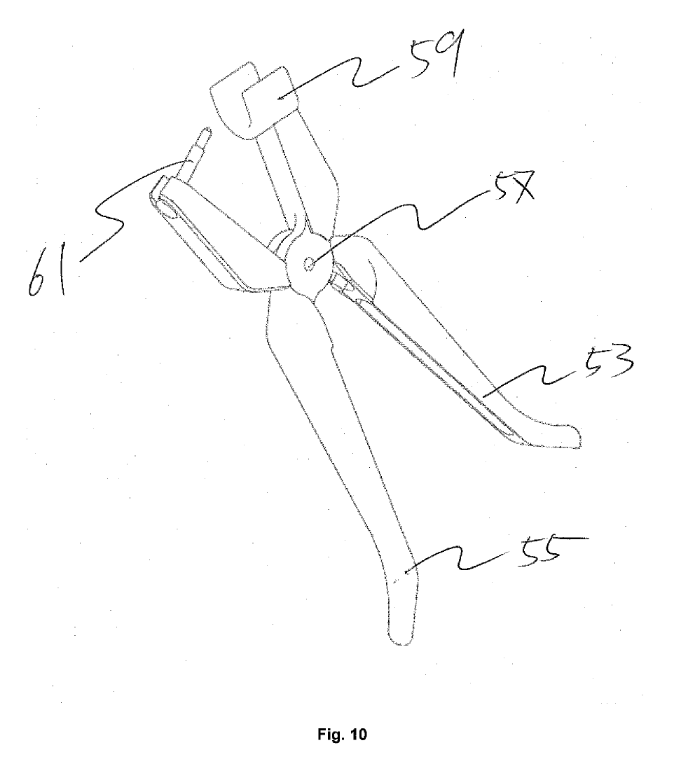

FIGS. 8, 9 and 10 depict the ear tag 11 and an exemplary embodiment of an installation tool 51. FIG. 10 depicts the installation tool 51 without the ear tag 11. The installation tool 51 comprises some elements of the conventional pliers such as a pair of opposing handles 53 and 55, a pivot 57 and a pair of jaws 59 and 61. One of the jaws has a pointed, male insertion or piercing portion 61, and the other is a U-shaped anvil that holds the ear against the insertion portion 61 during piercing. Male insertion or piercing portion 61 is pivotally mounted to the handle so it can be moved relative to the handle. FIG. 8 shows the tool 51 with the tag 11 positioned for installation with a male insertion portion 61 inserted into the interior bore 19 of the post 17. The male insertion or piercing member is pointed and rigid and provides the actual piercing of the animal's ear. As the installation tool 51 is closed, the prophylactic-membrane 21 covering the pointed tip of the male insertion member 61 goes through the front side of the ear and out the back side of the ear. The barbs 23 follow the pointed tip of the insertion member 61 through the ear and expand and come to rest on the back side of the ear, thereby anchoring the tag 11 in the ear.

In an alternative embodiment of the tool, the male insertion or piercing member is spring loaded so that the pointed tip extends beyond the terminal end of post 17 before and during posting, thereby preventing entry of material into bore 19. Upon completion of piercing, the tip of the insertion or piercing member retracts, leaving no pointed portion of piercing element 17. In this embodiment, no membrane is required.

Numerous variations, substitutions, modifications and simplifications will still fall within the scope of the inventions that are the subject of this application. Many other features, benefits and advantages of the inventions related to the embodiment referenced herein will be evident to those of skill in the art in light of the exhaustive review of prior art.

Even though the foregoing embodiment represents the most preferred at present, those of ordinary skill in the art will recognize many possible alternatives that we have not expressly suggested here. While the foregoing written descriptions enable one of ordinary skill to make and use what is considered presently to be best modes of the invention, those of ordinary skill will understand and appreciate the existence of variations, combinations and equivalents of the specific embodiment, method and examples herein. It should be understood that the drawings and detailed descriptions herein are not to be regarded in an illustrative rather than a restrictive manner, and are not intended to limit the invention to the particular forms of the examples disclosed. To the contrary, the invention includes any further modifications, changes, rearrangements, substitutions, alternatives, design choices, and embodiments apparent to those of ordinary skill and art, without departing from the spirit and scope of this invention, as defined by any claims included herewith or later added or amended in an application claiming priority to this present filing. The invention covers all embodiments within the scope and spirit of such claims, irrespective of whether such embodiments have been remotely referenced here or whether all features of such embodiments are known at the time of this filing. Thus, it is intended that the claims be interpreted to embrace all further modifications, changes, rearrangements, substitutions, alternatives, design choices, and embodiments that may be evident to those of skill in the art. In any case, all substantially equivalent systems, articles and methods should be considered within the scope of the present invention.

I claim:

1. An ear tag for attachment to an animal for identification, the ear tag comprising:
a piercing element including:
a post having a terminal end;
at least one expandable member carried by the post, the expandable member configured and dimensioned to be pierced through an ear of the animal and to expand and retain the post in the ear after piercing; and
an interior bore extending through the post to the terminal end, the bore dimensioned to receive a portion of a piercing tool; and
a tab portion secured to the piercing element, the ear tag shaped and dimensioned to receive an indicia for identifying the animal.

2. The ear tag according to claim 1, further comprising:
a membrane covering the bore at the terminal end of the post of the piercing element, the membrane preventing penetration of material into the bore during piercing.

3. The ear tag according to claim 1, wherein the tab portion is generally planar and the post extends generally perpendicular to the tab portion.

4. The ear tag according to claim 1, wherein the expandable member further comprises a plurality of barbs extending at an acute angle from the terminal end of the post, the barbs being sufficiently flexible to collapse around the post while being pierced through the ear and to expand radially outward from the post after piercing.

5. The ear tag according to claim 3, wherein at least one air aperture is provided through the tab proximal the post.

6. The ear tag according to claim 1, wherein the portion of the piercing tool received in the bore of the piercing element is pointed and rigid and provides the actual piercing of the animal's ear.

7. An ear tag for attachment to an animal for identification, the ear tag comprising:
a piercing element including:
a post having a terminal end;
at least one radially expandable barb carried by the post and extending rearwardly from the terminal end at an acute angle, the barb configured and dimensioned to be pierced through an ear of the animal and to expand and retain the post in the ear after piercing;
an interior bore extending through the post to the terminal end, the bore dimensioned to receive a portion of a piercing tool; and
a membrane covering the bore at the terminal end of the piercing element; and
a tab portion secured to the piercing element, the tab shaped and dimensioned to receive an indicia for identifying the animal.

8. The ear tag according to claim 7, wherein the tab portion is generally planar and the post extends generally perpendicular to the tab portion.

9. The ear tag according to claim 8, wherein at least one air aperture is provided through the tab proximal the post.

10. The ear tag according to claim 7, wherein the portion of the piercing tool received in the bore of the piercing element is pointed and rigid and provides the actual piercing of the animal's ear.

11. An ear tag for attachment to an animal for identification, the ear tag comprising:
a piercing element including:
a post having a terminal end;
a plurality of radially expandable barbs carried by the post and extending rearwardly from the terminal end at an acute angle, the barbs being sufficiently flexible to collapse around the post during piercing through the animal's ear and to radially expand after piercing to retain the ear tag on the ear;
an interior bore extending through the post to the terminal end, the bore dimensioned to receive a portion of a piercing tool; and
a membrane covering the bore at the terminal end of the piercing element; and
a generally planar tab portion secured to the piercing element perpendicular to the post, the ear tag shaped and dimensioned to receive an indicia for identifying the animal.

12. The ear tag according to claim 11, wherein at least one air aperture is provided through the tab proximal the post.

13. The ear tag according to claim 12, wherein the portion of the piercing tool received in the bore of the piercing element is pointed and rigid and provides the actual piercing of the animal's ear.
